(19) United States
(12) Patent Application Publication
(10) Pub. No.: US 2023/0380938 A1
(43) Pub. Date: Nov. 30, 2023

(54) ALIGNERS HAVING FORCE REGENERATION

(71) Applicant: uLab Systems, Inc., Memphis, TN (US)

(72) Inventors: Krishnamohan SHARMA, Milpitas, CA (US); Huafeng WEN, Redwood Shores, CA (US)

(73) Assignee: uLab Systems, Inc., Memphis, TN (US)

(21) Appl. No.: 18/322,028

(22) Filed: May 23, 2023

Related U.S. Application Data
(60) Provisional application No. 63/365,317, filed on May 25, 2022.

(51) Int. Cl. A61C 7/08

(52) U.S. Cl. CPC A61C 7/08

(57) ABSTRACT

Aligners having stress force regeneration attributes are described herein. In one variation, a force may be regenerated within the aligner by receiving an aligner within a receptacle post-use by a patient and applying thermal energy to the aligner such that the aligner is maintained at a predetermined temperature for a predetermined period of time.

### CROSS-REFERENCE TO RELATED APPLICATIONS

This application claims the benefit of priority to U.S. Prov. 63/365,317 filed May 25, 2022, which is incorporated herein by reference in its entirety.

### FIELD OF THE INVENTION

The present invention relates to methods and apparatus for orthodontics. More particularly, the present invention relates to methods and apparatus for the repeated regeneration of strength in materials used for orthodontic aligners.

### BACKGROUND OF THE INVENTION

Orthodontics is a specialty of dentistry that is concerned with the study and treatment of malocclusions which can result from tooth irregularities, disproportionate facial skeleton relationships, or both. Orthodontics treats malocclusion through the displacement of teeth via bony remodeling and control and modification of facial growth.

This process has been accomplished by using a number of different approaches such as the application of static mechanical forces to induce bone remodeling, thereby enabling teeth to move. Oftentimes, treatments include the use of aligners which are positioned upon the teeth to effect the movement of one or more teeth and these aligners are typically fabricated from polymers which are thermoformed to the patient's dentition.

However, the polymeric aligners due to their viscoelastic nature become ineffective in further moving the position of the teeth over treatment time due to stress relaxation of the aligner materials, in which case they do not achieve the objective of moving teeth efficiently like traditional nitinol wires. The aligners may be formed to be too soft for patient comfort reasons, and may apply inadequate amount of force, such aligners may be ineffective or inefficient in moving the teeth as the force imparted may be too low.

There is a need for maintaining the sustainable and predictable force applied onto teeth or an individual tooth over time to efficiently move them to accomplish the objective of the aligners. Furthermore, there is a need for optimizing the amount of force applied to the teeth over the course of treatment, for example, the stress applied to the teeth and rigidity of the aligners in the early days of therapy may be different compared to the latter days of therapy.

Accordingly, there exists a need for efficiently and effectively providing an aligner made of polymeric materials which can be optimized and regenerated for orthodontic applications without having to produce additional aligners.

### SUMMARY OF THE INVENTION

One example of a material which may be used to fabricate such an aligner may include a polymer capable of converting thermal energy into mechanical energy, where the intermolecular interactions in stress relaxed polymers are strengthened or reinforced by converting thermal energy into enthalpic energy. A select few polymers can convert thermal energy to restore intermolecular forces lost due to stress relaxation, when they are subjected to heat below their glass transition temperature. Further, a polymer in the modulus range of 600 MPa to 1700 MPa are particularly suitable as plastic aligners as they provide optimum force required for moving teeth upon stretching or under strain. Furthermore, plastics with elongation at yield higher than 3%, 4% or even 5% are suited as aligners due to their elastic properties. Also, for practical purposes the stress regeneration temperature preferably may be in the range of, e.g., 50° C. and 100° C. for any real-world applications. Several medical grade polymer types such as polyesters, co-polyesters, polyamides, polyurethanes, polycarbonates, polyolefins, polypropylenes, polyethylenes, polyacrylic, polylactic, polycaprolactone, polyhydroxyalkanoate, polybutylene succinate, starch based, polysaccharides, silicones, and others resins may regenerate the stress force under the above conditions. One particular polymer may include polyethylene terephthalate glycol (PETG) co-polymer with a modulus higher than 1000 MPa is capable of regenerating stress forces lost due to stress relaxation. Sheets of the co-polymer may be used to initially thermoform one or more aligners (e.g., comprised of a single layer of co-polymer or integrated into multi-layer of copolymer) which were designed and configured to treat one or more malocclusions using any of the methods and software as described in any of the references incorporated herein. In case of multi-layer polymeric structure, even if at least one of the polymers used is capable or discovered to regenerate stress force, it is to be understood that the entire aligner could positively contribute towards stress force regeneration. The aligner may be fabricated, for example, from a single layer of the co-polymer material or used in multiple layers of the same co-polymer or in a multi-layer fabrication using other polymeric materials. As the aligners are typically worn for a predetermined period of time per day over a course of several days, the aligners typically degrade and lose their strength resulting in a reduced amount of force applied upon the teeth by the aligner over the treatment period. However, the stress force in the aligners may be regenerated through methods applied when the aligners are not worn, e.g., before brushing the teeth, or eating meals, or overnight when the patient is not using the aligner and may be sleeping.

The PETG co-polymer may exhibit certain material properties which may facilitate imparting the force regeneration effects into the co-polymer, as described herein, when the co-polymer is exposed to a thermal treatment. In one variation, PETG co-polymers exhibiting at least one or more of the following properties may be utilized and the co-polymer may exhibit any number of combination of these properties: tensile strength at yield of 30-50 MPa or more, tensile stress at break of 40-60 MPa or more, elongation at yield of 4-6% or more, elongation at break of 150% or more, flexural modulus of 1400 MPa or more, hardness (Rockwell R Scale) of 100 or more, and glass transition temperature of 100-110° C. Without being bound by theory, it is generally believed that polymers with hard and soft segments exhibit stress restoration upon exposure to thermal energy with soft segment serving as a switch to restore the energy lost due to stress relaxation. However, it may be difficult to theoretically predict whether a certain polymer sheet exhibits stress restoration property or not; if it does, at what temperature and time conditions are appropriate for such a stress restoration. The experimental verification of the property is desirable to discover the polymers with stress restoration properties. It is also to be understood that certain thermoformed polymers (before stress relaxation) upon exposure to heat for extended time (e.g., greater than 5 minutes) may further strengthen their stress force values and exhibit better stress relaxation properties. It is believed that in the solid state, combination of kinetics and thermodynamic effects play a role in determining whether a system accomplishes local minima or global minimum energy state. Many a times, rapidly thermoformed plastics may not stabilize into global minimum state (that is, higher stress force values), and thereby readjust into thermodynamically stable state if they are exposed to external energy for prolonged time post thermoforming (e.g., 5 minutes to 100 minutes).

Such regenerated clear aligners may function similarly to shape memory materials such as nitinol such that they may exhibit identical or similar force profiles after use. For example, an aligner may be regenerated so that the appliance exhibits the same or similar force profile on day one or day seven or higher of use by the patient. Further, the force values exerted by regenerated aligners are highly predictable and controlled for achieving predictable, faster, and reliable teeth movement. Also, being able to track variation in force values with a sensor may enable us to monitor patient compliance (as described in further detail herein). It is also possible that if the stress force values are regenerated, the number of aligners typically used per case or treatment may be reduced, e.g., by 30-80%, generating less plastic waste and reducing the cost. One of the mechanisms for imparting stress force regeneration includes thermal energy which is converted into mechanical energy by strengthening the intermolecular interaction between the polymers molecules so that the aligner is able to regenerate its applied force upon teeth and is thus able to maintain a sustained level of force upon the teeth over the course of treatment using that aligner. One variation for how the force regeneration may be implemented includes an aligner already in use by the patient. The aligner itself may be formed using the 3D model of the patient dentition which may then be used to create one or more digital 3D models of the corrected dentition for designing the corresponding one or more aligner models used in a treatment plan for correcting one or more malocclusions. This may result in the fabrication of multiple aligners which may be used in series or selectively depending upon the treatment plan for a particular patient.

With the 3D model of the corrected patient dentition, the corresponding mold may be fabricated for thermoforming the corresponding aligner. Alternatively, the corresponding aligner may be fabricated using any number of additive manufacturing processes such as 3D printing. With the one or more aligners formed, they may be provided to the patient for treatment in which case the patient (or the practitioner or another third party provider) may use the aligner for the prescribed treatment period during which they may apply one or more heat treatments to the aligner (when not in use) to regenerate the force applied by the aligner upon the teeth. The heat treatment may be applied to the aligner, for instance, daily while optionally simultaneously cleaning the aligner, or the heat treatments may be applied upon the aligner periodically. For example, one or more heat treatments may be applied upon the aligner at the beginning of use of that aligner or near the end of use of that aligner and the heat treatments may be applied repeatedly if so desired until use of that aligner is completed and the subsequent aligner is used by the patient in which case the subsequent aligner may be heat treated in a similar manner.

The method of thermal energy application may be repeated any number of times over the use of the aligner and the form of thermal energy may be varied depending upon the desired application. One example for applying thermal energy may include placing the aligner within a receptacle, container, or bath of water which is heated to an appropriate temperature (e.g., 50°-100° C.). Alternatively, the water may be heated up to, e.g., 80° C., and in other variations the water may be heated up to, e.g., 95° C. The aligner may be maintained within the water for a predetermined period of time, e.g., up to 1-5 minutes or longer, to allow the aligner to regenerate. The time temperature requirements for force regeneration may alter and can be refined depending upon the specific characteristics of the aligner (e.g., chemical structure, thickness, etc.). Typically, use of lower temperatures may require longer heat exposure times to regenerate the force and vice versa where higher temperatures may require shorter heat exposure times. It is also possible that for prolonged heating, the stress force and stress retention values may be substantially improved in the aligner. The aligner may be then removed from the water bath for storage or use by the patient. Aside from water, other liquids or aqueous solutions may also be used for effectively transferring the thermal energy to the aligner, e.g., alcohols, polyglycol, glycerine, salt water, water laced with surfactants or cleaning-agents, mouth fresheners, antibacterial, etc.

Application of the heat treatment to the aligner may increase the stress retention (e.g., up to 10%-70% increase) as well as provide an increase in force applied as well (e.g., up to 10%-70% increase). Increase in stress retention depends on the stage of the stress relaxed aligner prior to heat treatment. Every time the aligner undergoes a force regeneration, the initial force characteristics of the aligner may be restored back to its initial condition or close to its initial condition. The longer the thermal energy is applied to the aligner, the performance of the aligner may potentially increase beyond the original performance characteristics of the aligner.

Any number of alternative energy modalities may be used to apply thermal energy to the aligner, e.g., electrical, hydrothermal, ultrasonic, radiative, electromagnetic (ultraviolet, infrared, solar, etc.), chemical, convective heat, conductive heat, etc. or any combination of the various different types of energy modalities may be used. One additional variation may include the application of heat conducted to the aligner through the use of an exothermal reaction used to heat the aligner. In this example, a pouch having a number of chemicals which undergo an exothermic reaction may be placed within a water bath to heat the water to the appropriate temperature (e.g., 60°-100° C.) into which the aligner may be placed. Examples of exothermic chemicals include, but are not limited to, hydration reactions involving metal oxides (e.g., CaO, MgO), acid-base reactions, redox reactions and thermite reactions. Alternatively, the water may be heated up to, e.g., 80° C., and in other variations the water may be heated up to, e.g., 95° C. The aligner may be kept in the water for a predetermined period of time, e.g., up to 1-2 minutes or longer, to allow the aligner to regenerate and then removed from the water bath. The pouch may also be removed and reused for a subsequent heat regeneration session. The aligner can be regenerated at any frequency as desired and/or recommended by medical practitioners, such as once after every use of the aligner by the patient or once after a predetermined period of time, e.g., 5 hours, 12 hours, 24 hours, 48 hours, 72 hours, 96 hours, or even once a week or once a month. Typically the aligners may be regenerated more frequently than retainers.

Another variation may include where the post processing thermal energy application may be performed at the time of manufacture so that the aligner starts with a relatively higher force profile which can degrade over time. In this case, the patient may omit the force regeneration methods entirely and simply use the aligner per usual. Alternatively, the patient may also optionally implement the thermal energy application to further improve the force regeneration of the aligner over the course of treatment.

As the aligner fabricated as described herein may be formed of a single material layer (rather than multiple layers of material) having a single thickness, the amount of force retention which can be imparted by the aligner may be adjusted by altering the processing steps. For example, an aligner used at the beginning of an aligner treatment may require a relatively low force retention and may be thermoformed as usual. The aligner during the middle of an aligner treatment may require a medium force and the thermoforming process may accordingly be modulated with an aligner temperature treatment applied. The aligner during the end of an aligner treatment may require a higher force and the aligner may accordingly have one or more aligner temperature treatments applied to increase the amount of force retention.

The aligner may be placed within a receptacle, container, or bath filled with a fluid such as water for applying the thermal treatment for force regeneration. The container may be filled with a number of fluids besides water or aqueous solutions containing other solutes or solvents, e.g., polyglycol, glycerine, etc. for transferring the heat which may be generated via a heating element. This heating element may include an electric heating element, chemical, or any of the other heating modalities as described herein. The container may also optionally include one or more pressure sensing elements such as load cells between which the aligner may be positioned for measuring the amount of force retention on the aligner. The pressure sensing elements as well as heating element may be optionally coupled (wirelessly or wired) to a controller which may include an integrated controller or which may also include a smartphone or other computing device which can receive measurements and signals from the respective components and which can also be programmed to communicate and/or control the components as well. The pressure or force sensors may give a read out on the stress force lost over a period or regenerated during exposure to a heat source. The read-out from pressure sensors could be used to track patient compliance or aligner usage time. The microprocessor can automatically communicate with the patient or orthodontist via Bluetooth or Wifi to set up reminders and ensure the patient compliance. Hence, the stress force applied by the aligners onto teeth is more predictable and controlled, and can enable the accurate movement of teeth.

In one example, the patient can place the aligner after use within the container and bath to heat treat and/or simultaneously clean the aligner for the prescribed period of time and at the prescribed temperature. The assembly can also be used to determine the amount of force retention on the aligner via the pressure sensing elements for determining via the controller the force retention as well as patient compliance as the controller may correlate how long the aligner has been used as well as determine when the sufficient amount of force has been regenerated within the aligner.

One method of regenerating a force within an aligner may generally comprise receiving an aligner within a receptacle post-use by a patient and applying thermal energy to the aligner such that the aligner is maintained at a predetermined temperature for a predetermined period of time.

Another method of regenerating a force within an aligner may generally comprise forming an aligner and applying thermal energy to the aligner such that the aligner is maintained at a predetermined temperature for a predetermined period of time.

One variation of an aligner apparatus configured to regenerate a force may generally comprise an aligner configured to correct a malocclusion of a patient dentition, wherein the aligner is formed of a PETG co-polymer and a receptacle configured for receiving the aligner and applying thermal energy to the aligner such that the aligner is maintained at a predetermined temperature for a predetermined period of time.

### BRIEF DESCRIPTION OF THE DRAWINGS

FIG. 1A shows how an aligner fabricated from a polymer or co-polymer may be thermally treated for regenerating the stress retention and material strength of the aligner.

FIG. 1B shows a schematic illustration demonstrating how a newly formed aligner may lose some of its force retention after use by the patient due to mechanical energy being expended through use and how the appropriate thermal energy applied may regenerate the aligner.

FIG. 2A illustrates a flow diagram which shows one variation for how the force regeneration may be implemented with an aligner already in use by the patient.

FIG. 2B illustrates another variation where the post processing thermal energy application may be performed at the time of manufacture so that the aligner starts with a relatively higher force profile which can degrade over time.

FIG. 3 shows a pound force retention graph of aligners which have been measured for the amount of force that aligners impart over time.

FIGS. 4A and 4B illustrate examples of an aligner degradation over time in comparison to a regenerated aligner.

FIG. 5 illustrates a chart illustrating how the different processing steps may be implemented accordingly depending upon the desired aligner characteristics.

FIG. 6 illustrates one variation of an aligner heating device for applying the thermal treatment for force regeneration along with force sensors.

### DETAILED DESCRIPTION OF THE INVENTION

An oral appliance such as an aligner which applies and maintains a consistent force upon the teeth while minimizing the change in the stress applied over the length of the treatment period may be generally accomplished by converting thermal energy applied to the oral appliance or aligner into mechanical energy stored by the oral appliance or aligner using the apparatus and methods described herein. Furthermore, such an aligner may be customizable to provide a force profile for tooth movement according to individual patient treatments. Such aligners may be fabricated from using any safe medical grade or biodegradable resins such as polyesters, co-polyesters, polyamides, polyurethanes, polycarbonates, polyolefin, polypropylenes, polyethylenes, polyacrylic, polylactic, polycaprolactone, polyhydroxyalkanoate, polybutylene succinate, starch based, polysaccharides, silicones, and innumerable others resins and their combinations known to those skilled in the art. As long as the polymer exhibits the property of regenerating the stress force upon thermal treatment (e.g., after undergoing stress relaxation) as described herein. Moreover, such an aligner may be direct 3D printed or thermoformed within an orthodontic office locally.

When treating a patient in correcting malocclusions in their dentition with aligners placed upon the teeth, it is generally desirable to apply a consistent force upon the tooth or teeth to be moved over time without the applied force decaying over the period of treatment while the patient uses the aligner. As an example, an aligner which has been used by a patient over a course of treatment may present an initial force, e.g., 300-4000 grams, applied against the patient's teeth (as measured on corresponding thermoformed plastic sheets at strain 1%-5%). However, the amount of force applied by the aligner upon the teeth may rapidly decay over the treatment period, e.g., 4-5 days or 60 hours, leaving the aligner ineffective for moving the patient's teeth near the end of the treatment period until the subsequent aligner is applied or until the treatment is completed. In the case of a subsequent aligner being used, the initial force applied may be uncomfortable to the patient given the prior loose aligner.

With treatment planning software utilizing aligners or other orthodontic devices, particular treatment planning processes and orthodontic aligners which may be used in any combination with the methods and materials described herein are described in further detail in U.S. Pat. Nos. 10,624,717; 10,335,250; 10,631,953; 10,357,336; 10,357,342; 10,588,723; as well as U.S. Pat. Pubs. 2017/0100208; 2019/0321135; 2020/0205936; 2019/0343602; 2020/0170762; 2018/0078343; 2018/0078344; 2018/0078335; 2020/0146775. The details of these references are incorporated herein by reference in their entirety and for any purpose.

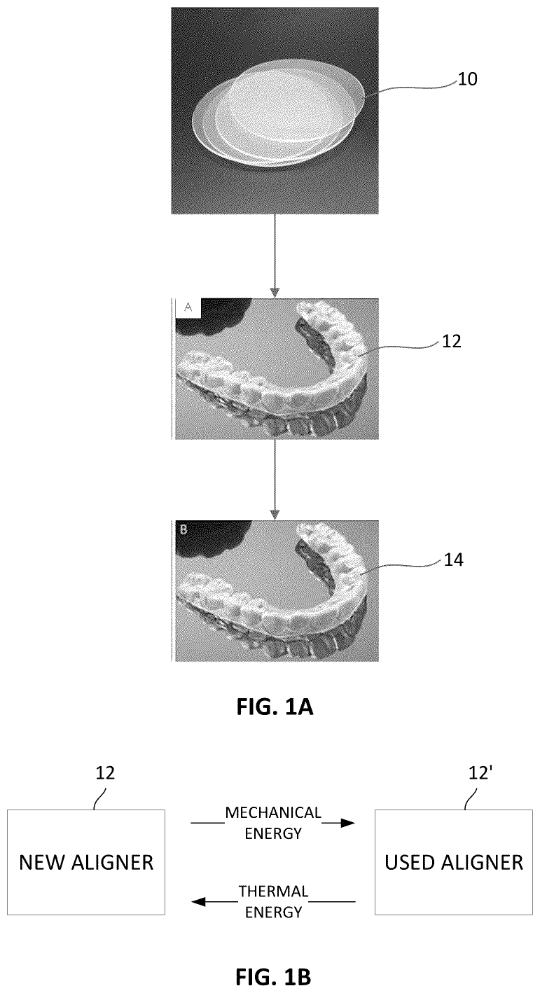

One example in particular of a material which may be used to fabricate such an aligner may include polyethylene terephthalate glycol (PETG) co-polymer. The PETG co-polymer may exhibit certain material properties which may facilitate imparting the force regeneration effects into the co-polymer, as described herein, when the co-polymer is exposed to a thermal treatment. In one variation, PETG co-polymers exhibiting at least one or more of the following properties may be utilized and the co-polymer may exhibit any number of combination of these properties: tensile strength at yield of 30-50 MPa or more, tensile stress at break of 40-60 MPa or more, elongation at yield of 4-6% or more, elongation at break of 150% or more, flexural modulus of 1400 MPa or more, hardness (Rockwell R Scale) of 100 or more, and glass transition temperature of 100-110° C. Some examples of suitable PETG co-polymers may include materials Tritans (Eastman Chemical Company, NY, NY). Sheets 10 of the co-polymer, such as that show in FIG. 1A, may be used to initially thermoform one or more aligners 12 (e.g., comprised of a single layer of co-polymer) which were designed and configured to treat one or more malocclusions using any of the methods and software as described in any of the references incorporated above. The aligner 12 may be fabricated, for example, from a single or multi-layer of the polymeric material, as long as the material in use undergoes shape change or stress force restoration upon exposure to heat. In one variation, the one or more aligners 12 may be formed and provided to the patient for use by wearing the aligner upon their teeth. As the aligners are typically worn for a predetermined period of time per day over a course of several days, the aligners typically degrade and lose their strength resulting in a reduced amount of force applied upon the teeth by the aligner over the treatment period. However, the stress force in the aligners may be regenerated through methods applied when the aligners are not worn, e.g., overnight when the patient is sleeping or during brushing or eating. During these periods, a predetermined level of heat (e.g., greater than 50° C.) may be applied to the aligner over a predetermined period of time so that the bonds between the polymers which become stretched over time and use are reformed with the application of heat so that the polymer strands pack tightly to regain their most stable form.

The material of the present aligner may be compared against conventional materials typically used to fabricate aligners. Such materials may include, for example, Essix ACE® Plastic (Dentsply Sirona, Charlotte, NC). The present aligner with the force regeneration methods may present a relatively higher stress retention and higher impact strength than an aligner fabricated from Essix ACE. While the present aligner may undergo a force regeneration thermal energy application multiple times, the application of heat to an aligner fabricated from Essix ACE may potentially degrade the shape of that aligner instead.

The applied thermal energy is converted into mechanical energy so that the aligner 14 is able to regenerate its applied force upon teeth and is thus able to maintain a sustained level of force upon the teeth over the course of treatment using that aligner. FIG. 1B shows a schematic illustration demonstrating how a newly formed aligner 12 may lose some of its force retention after use by the patient due to mechanical energy being expended through use so that the aligner 12 becomes a used aligner 12′. By applying the appropriate thermal energy (or other energy forms as described herein), as shown, the stress forces lost under constant strain can be regenerated so that the used aligner 12′ regains or regenerates back to its initial form.

We have demonstrated the stress force restoration property using a thermoformed sheet aligner material (as described herein) and subjected it to a strain for 24 hours under water at 37° C. and restored the loss in stress forces by subjecting it to a heat treatment of around 75°-85° C. for 1-2 minutes. Typically, there will be a steep drop in the stress force in first 5 hours followed by a gradual or negligible drop in stress force after 5 hours. As an example, if initial stress force is 100%, the drop in stress force at 5 hours under 4-5% strain (in water at 37° C.) will be in the range of 30%-60%, the drop in stress force at 24 hours will be in the range of 40%-65% depending upon experimental conditions used.

Surprisingly, when the aligners are subjected to a heat treatment, the force values were restored close to 100%. At times, the stress retention values upon stress force regeneration are also improved. The force regeneration is not a universal property as some conventional aligners may not regenerate the force values including those aligners marketed as Taglus (Mumbai, India), American Orthodontics (Sheboygan, WI), Biocryl (Iserlohn, Germany), and Zendura-A (Fremont, CA) are a few to be mentioned. A number of polymeric materials that can strengthen its intermolecular interactions between polymers by absorbing thermal energy may exhibit force regeneration properties as described herein.

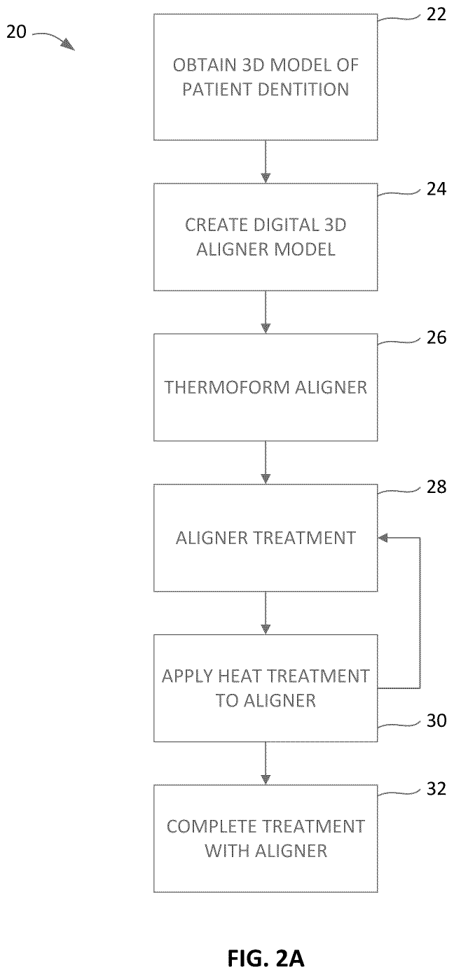

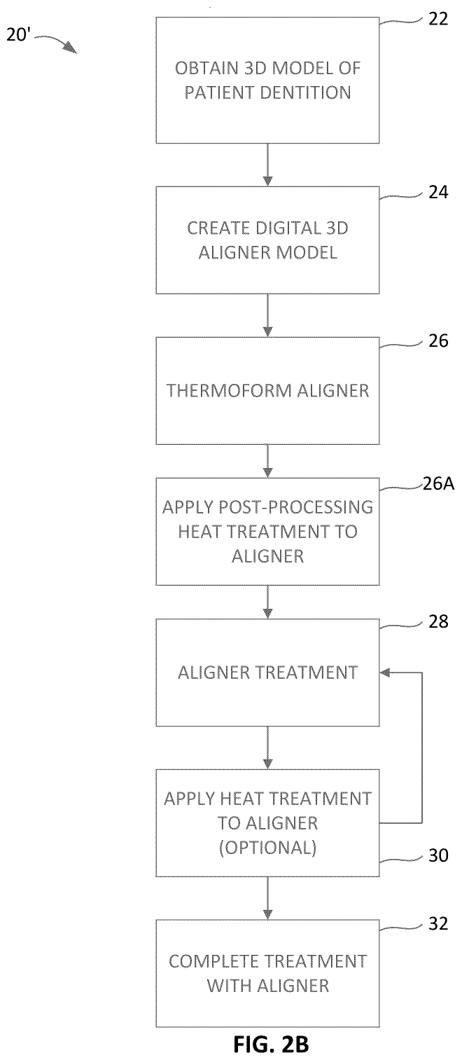

FIG. 2A illustrates a flow diagram 20 which shows one variation for how the force regeneration may be implemented with an aligner already in use by the patient. The aligner itself may be formed using the 3D model of the patient dentition 22 which may then be used to create one or more digital 3D models of the corrected dentition for designing the corresponding one or more aligner models 24 used in a treatment plan for correcting one or more malocclusions. This may result in the fabrication of multiple aligners which may be used in series or selectively depending upon the treatment plan for a particular patient.

With the 3D model of the corrected patient dentition 22, the corresponding mold may be fabricated for thermoforming the corresponding aligner 26. Alternatively, the corresponding aligner may be fabricated using any number of additive manufacturing processes such as 3D printing. With the one or more aligners formed, they may be provided to the patient for treatment 28 in which case the patient (or the practitioner or another third party provider) may use the aligner for the prescribed treatment period during which they may apply one or more heat treatments to the aligner (when not in use) 30 to regenerate the force applied by the aligner upon the teeth. When the aligner is first provided to the patient without the application of any thermal treatments, the aligner exhibit a relatively lower strength and may be more comfortable to wear by the patient. As the aligner is used by the patient and the teeth are moved accordingly, the thermal treatment may be applied in order to increase the strength of the aligner (regain the stress forces lost due to stress relaxation) so as to complete the remainder of the teeth movement. In this manner, the aligner may begin to relax near the completion of the movement and give up some of the moment imparted by the aligner as well. The heat treatment may be applied to the aligner, for instance, daily while optionally simultaneously cleaning the aligner, or the heat treatments may be applied upon the aligner periodically 28. For example, one or more heat treatments may be applied upon the aligner at the beginning of use of that aligner or near the end of use of that aligner and the heat treatments may be applied repeatedly if so desired 28 until use of that aligner is completed 32 and the subsequent aligner is used by the patient in which case the subsequent aligner may be heat treated in a similar manner.

The method of thermal energy application may be repeated any number of times over the use of the aligner and the form of thermal energy may be varied depending upon the desired application. One example for applying thermal energy may include placing the aligner within a receptacle, container, or bath of water which is heated to an appropriate temperature (e.g., 50°-100° C.). Alternatively, the water may be heated up to, e.g., 80° C., and in other variations the water may be heated up to, e.g., 95° C. The aligner may be maintained within the water for a predetermined period of time, e.g., up to 1-5 minutes or longer, to allow the aligner to regenerate. The aligner may be then removed from the water bath for storage or use by the patient. Aside from water, other liquids may also be used for effectively transferring the thermal energy to the aligner, e.g., polyglycol, glycerine, etc.

Application of the heat treatment to the aligner (depending upon strain applied and usage stage) may increase the stress retention (e.g., up to 60% increase) as well as provide an increase in force regenerated as well (e.g., up to 60% increase). Every time the aligner undergoes a force regeneration, the initial force characteristics of the aligner may be restored back to its initial condition or close to its initial condition. The longer the thermal energy is applied to the aligner, the performance of the aligner may potentially increase beyond the original performance characteristics of the aligner.

Any number of alternative energy modalities may be used to apply thermal energy to the aligner, e.g., electrical, hydrothermal, ultrasonic, radiative, electromagnetic (ultraviolet, infrared, etc.), convective, chemical, etc. or any combination of the various different types of energy modalities may be used. One additional variation may include the application of heat conducted to the aligner through the use of an exothermal reaction used to heat the aligner. In this example, a pouch having a number of chemicals which undergo an exothermic reaction may be placed within a water bath to heat the water to the appropriate temperature (e.g., 50°-100° C.) into which the aligner may be placed. Alternatively, the water may be heated up to, e.g., 80° C., and in other variations the water may be heated up to, e.g., C. The aligner may be kept in the water for a predetermined period of time, e.g., up to 1-5 minutes or longer, to allow the aligner to regenerate and then removed from the water bath. The pouch may also be removed and reused for a subsequent heat regeneration session.

While FIG. 2A illustrates how the force regeneration may be implemented with an aligner already in use by the patient or after the aligner has been given to the patient, FIG. 2B illustrates another variation where the post processing thermal energy application may be performed at the time of manufacture so that the aligner starts with a relatively higher force profile which can degrade over time. In this case, the patient may omit the force regeneration methods entirely and simply use the aligner per usual. Alternatively, the patient may also optionally implement the thermal energy application to further improve the force regeneration of the aligner over the course of treatment. Flow diagram 20′ illustrates the steps similarly to that shown in FIG. 2A but once the aligner has been thermoformed 26, the aligner may undergo a post-processing heat treatment 26A at the time of fabricating the aligner using the methods described herein to further improve the force characteristics of the aligner prior to use by the patient. After the heat treatment 26A, the aligner may be provided to the patient who may then use the aligner provided as-is without any further thermal energy application. Alternatively, the patient may optionally also apply the heat treatment to the aligner 30 to further improve the force characteristics of the aligner until the use of that particular aligner is completed 32.

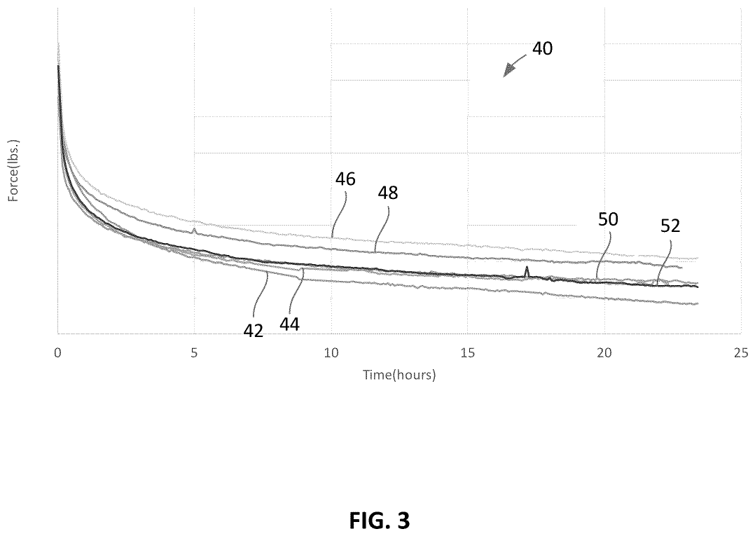

To illustrate the comparative effects of force regeneration in an aligner through thermal treatment, FIG. 3 shows a pound force retention graph 40 of aligners which have been measured for the amount of force that aligners impart over time. The plot shows the repeated regeneration of force every 24 hours as an example. Plot 42 illustrates the baseline force retention of an aligner fabricated from a material described herein (e.g., PETG co-polymer such as Tritan series) and the resulting measured pound force retention over time without having undergone a thermal treatment for comparison. Note that the force profile of the aligner on day 6 is identical to that of force profile of the same aligner on day 1 unlike any conventional aligner which typically fails to exhibit an identical force profile after being in use. The differences between stress force profiles are within the experimental error and standard deviation. After a single thermal treatment, the aligner is shown to increase the amount of force retention over time as shown by plot 44. However, the aligner after having undergone a second thermal treatment is shown in plot 46 to significantly increase its force retention beyond the baseline untreated aligner. A subsequent third thermal treatment is illustrated by plot 48 as well as fourth thermal treatment illustrated by plot 50 and fifth thermal treatment illustrated by plot 52. Over time, even if the regenerated level of force retention may slightly decrease (or increase) over subsequent thermal treatments, the resulting level is still shown to be relatively higher than the force retention of an aligner which remains untreated by any thermal treatments.

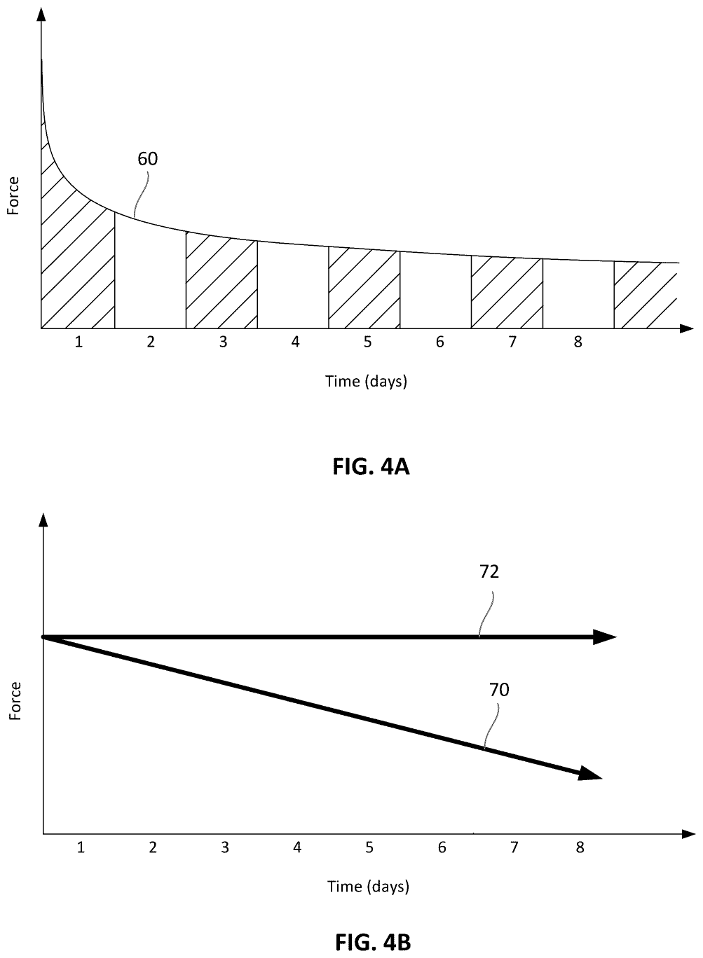

FIG. 4A illustrates another example showing plot 60 of the baseline force retention of the aligner fabricated from a material described herein and the resulting measured pound force retention without having undergone a thermal treatment measured over a period of several days. Each of the areas denoted under the curve represents an average stress force experienced by the teeth in a day of use by the patient. That is, the force applied by conventional aligners changes dynamically and reduces over time thereby making it more difficult to move teeth faster and predictably and may require several refinements. FIG. 4B generally illustrates a representative conventional aligner in plot 70 illustrating the decrease of force over time when in use by the patient. With force regeneration, plot 72 illustrates a representative aligner, as described herein, thermally treated over the course of several days so that the aligner exerts a consistent force profile (area under the curve) and predictably moves teeth.

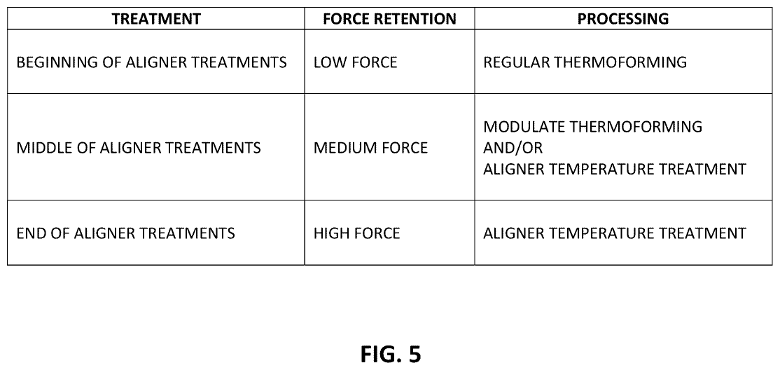

As the aligner fabricated as described herein may be formed of a single material layer (rather than multiple layers of material) having a single thickness, the amount of force retention which can be imparted by the aligner may be adjusted by altering the processing steps. However, it is to be understood that one can integrate force regenerating polymers into multi-layer structures to exploit the force regeneration properties. FIG. 5 illustrates a chart illustrating how the different processing steps may be implemented accordingly depending upon the desired aligner characteristics. For example, an aligner used at the beginning of an aligner treatment may require a relatively low force retention and may be thermoformed as usual. The aligner during the middle of an aligner treatment may require a medium force and the thermoforming process may accordingly be modulated with an aligner temperature treatment applied. The aligner during the end of an aligner treatment may require a higher force and the aligner may accordingly have one or more aligner temperature treatments applied to increase the amount of force retention.

The amount of scrap created during the thermo-formation of an aligner could be anywhere from 50-85%. The plastic scrap of PETG formed during themoformation could be recycled as it is not contaminated with multiple layered materials. It is also possible that used aligner formed of PETG could be recycled after use of the aligner, minimal plastic waste may be created. Furthermore, as aligner fabrication may result in scrap plastic (e.g., an aligner results in 80% scrap of the starting sheet material), the scrap may also be recycled for use in new aligners thus lowering waste and raw material costs while keeping the entire process environmentally friendly.

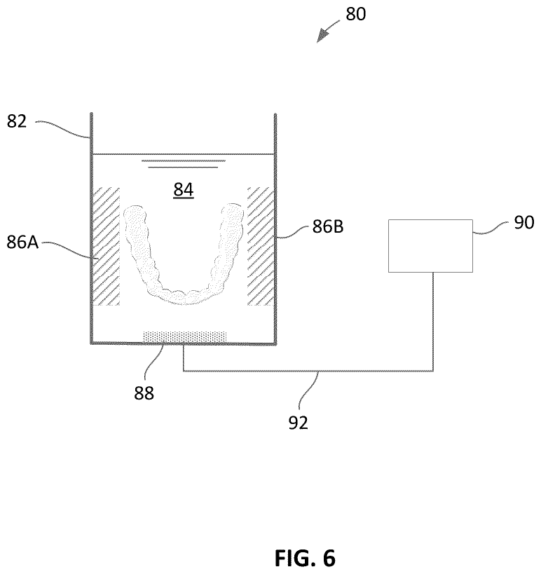

As described herein, the aligner may be placed within a receptacle, container, or bath 82 filled with a fluid 84 such as water for applying the thermal treatment for force regeneration, as shown in the container assembly 80 of FIG. 6. The container 82 may be optionally filled with a number of different fluids besides water, e.g., polyglycol, glycerine, etc. for transferring the heat which may be generated via a heating element 88. Additionally and/or optionally, aligner cleaning agents (e.g., surfactants, oxidizing agents, etc.) and/or refreshing agents (e.g., mint, etc.) can also be introduced to the fluid before or after or during thermal treatment in such a way that the aligner will regenerate its force while being simultaneously cleaned and may also give a fresh taste to the user. This heating element 88 may include an electric heating element, chemical, or any of the other heating modalities as described herein. An ultrasonic module may also be integrated into heating element to provide efficient cleaning and uniform mixing of water/liquids used. The container 82 may also optionally include one or more pressure sensing elements 86A, 86B such as load cells between which the aligner may be positioned for measuring the amount of force retention on the aligner. The pressure sensing elements as well as heating element may be optionally coupled 92 (wirelessly or wired) to a controller 90 which may include an integrated controller or which may also include a smartphone or other computing device which can receive measurements and signals from the respective components and which can also be programmed to communicate and/or control the components as well as programmed to receive data or other information from the controller. Additionally and/or alternatively, a display or monitor may also be optionally in communication with the controller 90 for displaying information to the user.

In one example, the patient can place the aligner after use within the container 82 and bath to heat treat and/or simultaneously clean the aligner for the prescribed period of time and at the prescribed temperature, as described herein. The assembly can also be used to determine the amount of force retention on the aligner via the pressure sensing elements 86A, 86B for determining via the controller 90 the force retention as well as patient compliance as the controller may correlate how long the aligner has been used as well as determine when the sufficient amount of force has been regenerated within the aligner.

The applications of the devices and methods discussed above are not limited to the one described but may include any number of further treatment applications. Modification of the above-described assemblies and methods for carrying out the invention, combinations between different variations as practicable, and variations of aspects of the invention that are obvious to those of skill in the art are intended to be within the scope of the claims.

What is claimed is:

1. A method of regenerating a force within an aligner, comprising:
receiving an aligner within a receptacle post-use by a patient; and
applying thermal energy to the aligner such that the aligner is maintained at a predetermined temperature for a predetermined period of time.

2. The method of claim 1 wherein receiving the aligner comprises immersing the aligner within a container filled with a fluid.

3. The method of claim 2 wherein the fluid comprises water, aqueous solution, organic solvent, or any combination thereof.

4. The method of claim 3 wherein the organic solvent comprises polyglycol or glycerine.

5. The method of claim 1 wherein receiving the aligner comprises applying a cleaning or oxidizing agent upon the aligner.

6. The method of claim 1 wherein receiving the aligner comprises applying a mouth freshening agent or oil upon the aligner.

7. The method of claim 1 wherein receiving the aligner comprises immersing the aligner into an antibacterial agent.

8. The method of claim 1 wherein receiving the aligner further comprises measuring a force imparted by the aligner upon one or more pressure sensors.

9. The method of claim 1 wherein applying thermal energy comprises applying an energy modality comprising electrical, hydrothermal, ultrasonic, radiative, electromagnetic, ultraviolet, infrared, or chemical heating.

10. The method of claim 1 wherein applying thermal energy comprises maintaining the aligner at the predetermined temperature between 50°-100° C.

11. The method of claim 1 wherein applying thermal energy comprises maintaining the aligner at the predetermined temperature of up to 80° C.

12. The method of claim 1 wherein applying thermal energy comprises maintaining the aligner at the predetermined temperature of up to 95° C.

13. The method of claim 1 wherein applying thermal energy comprises maintaining the aligner at the predetermined period of time of 1-5 minutes.

14. The method of claim 1 wherein applying thermal energy comprises placing an exothermic reactant into water and in thermal communication with the aligner.

15. The method of claim 1 wherein applying thermal energy comprises applying the thermal energy until a stress retention within the aligner increases at least 10%.

16. The method of claim 1 wherein applying thermal energy comprises applying the thermal energy until a force recovery within the aligner increases at least 10%.

17. The method of claim 1 wherein the aligner comprises a PETG co-polymer material.

18. The method of claim 1 further comprising monitoring the aligner within the receptacle via a controller.

19. A method of regenerating a force within an aligner, comprising:
forming an aligner; and
applying thermal energy to the aligner such that the aligner is maintained at a predetermined temperature for a predetermined period of time.

20. The method of claim 19 wherein forming the aligner comprises thermoforming the aligner.

21. The method of claim 19 further comprising receiving the aligner within a receptacle post-use by a patient.

22. The method of claim 21 wherein receiving the aligner comprises immersing the aligner within a container filled with a fluid.

23. The method of claim 22 wherein the fluid comprises water, aqueous solution, organic solvent, or any combination thereof.

24. The method of claim 23 wherein the organic solvent comprises polyglycol or glycerine.

25. The method of claim 21 wherein receiving the aligner further comprises measuring a force imparted by the aligner upon one or more pressure sensors.

26. The method of claim 19 wherein applying thermal energy comprises applying an energy modality comprising electrical, hydrothermal, ultrasonic, radiative, electromagnetic, ultraviolet, infrared, or chemical heating.

27. The method of claim 19 wherein applying thermal energy comprises maintaining the aligner at the predetermined temperature between 50°-100° C.

28. The method of claim 19 wherein applying thermal energy comprises maintaining the aligner at the predetermined temperature of up to 80° C.

29. The method of claim 19 wherein applying thermal energy comprises maintaining the aligner at the predetermined temperature of up to 95° C.

30. The method of claim 19 wherein applying thermal energy comprises maintaining the aligner at the predetermined period of time of 1-5 minutes.

31. The method of claim 19 wherein applying thermal energy comprises placing an exothermic reactant into water and in thermal communication with the aligner.

32. The method of claim 19 wherein applying thermal energy comprises applying the thermal energy until a stress retention within the aligner increases at least 10%.

33. The method of claim 19 wherein applying thermal energy comprises applying the thermal energy until a force recovery within at least 10%.

34. The method of claim 19 wherein the aligner comprises a PETG co-polymer material.

35. The method of claim 19 further comprising monitoring the aligner within the receptacle via a controller.

36. An aligner apparatus configured to regenerate a force, comprising:
an aligner configured to correct a malocclusion of a patient dentition, wherein the aligner is formed of a PETG co-polymer; and
a receptacle configured for receiving the aligner and applying thermal energy to the aligner such that the aligner is maintained at a predetermined temperature for a predetermined period of time.

37. The apparatus of claim 36 wherein the receptacle comprises a water bath.

38. The apparatus of claim 36 wherein the receptacle further comprises a heating element.

39. The apparatus of claim 36 wherein the receptacle further comprises one or more pressure sensors for contacting the aligner.

40. The apparatus of claim 36 further comprising a controller in communication with the receptacle.

41. The apparatus of claim 40 further comprising a display in communication with the controller.

42. The apparatus of claim 40 further comprising a smartphone in wireless communication with the controller.

43. An apparatus comprising:
a thermoformed aligner,
wherein the aligner is exposed to heat for more than 10 minutes prior to use by a patient such that a stress retention and a stress force within the aligner increases prior to exposure of the heat.

44. The apparatus of claim 43, wherein the temperature of the heat is between 50°-100° C.
